(19) United States
(12) Patent Application Publication
(10) Pub. No.: US 2014/0149064 A1
(43) Pub. Date: May 29, 2014

(54) TEMPERATURE MONITOR

(71) Applicant: ANIMAWARE LTD, Gloucester (GB)

(72) Inventor: Victoria DAVIDSON, Gloucester (GB)

(73) Assignee: Animaware Ltd, Gloucester (GB)

(21) Appl. No.: 13/688,761

(22) Filed: Nov. 29, 2012

(51) Int. Cl. G06F 15/00

(52) U.S. Cl. CPC G06F 15/00
USPC 702/130

(57) ABSTRACT

A temperature monitor for remote temperature monitoring is provided. The temperature monitor includes a display screen and at least one user-operable key or switch. A communication unit, typically in the form of a cellular telephone module or modem, is provided for transmitting and receiving signals. A temperature sensor measures ambient temperature. A processor unit is programmable with an upper temperature setpoint and a lower temperature setpoint and these are stored in the processor unit and compared against the measured ambient temperature. The processor unit controls the communication unit to transmit an alarm signal if the measured ambient temperature is above the upper temperature setpoint or below the lower temperature setpoint. The processor unit also controls the communication unit to transmit a status signal when the communication unit receives a demand signal, typically from a cellular telephone or other portable electronic device. The temperature monitor can be a portable device or physically integrated into a motor vehicle, for example.

### FIELD OF THE INVENTION

The present invention relates to temperature monitors, and in particular to portable and integrated electronic devices for monitoring ambient temperature.

### SUMMARY OF THE INVENTION

The present invention provides a temperature monitor comprising: a display screen; at least one user-operable key; a communication unit for transmitting and receiving signals; a temperature sensor for measuring ambient temperature; and a processor unit programmable with an upper temperature setpoint and/or a lower temperature setpoint; wherein the processor unit controls the communication unit to transmit an alarm signal containing data indicative of the ambient temperature measured by the temperature sensor if the ambient temperature reaches or exceeds the upper temperature setpoint or the lower temperature setpoint; and wherein the processor unit controls the communication unit to transmit a status signal containing data indicative of the ambient temperature measured by the temperature sensor when the communication unit receives a demand signal.

The temperature monitor can be provided as a portable device. The portable device can include an outer housing which contains the communication unit, temperature sensor (although an external temperature sensor can also be optionally connected to the portable device by suitable wired or wireless means), processor unit, and the like, and on which the display screen and the at least one user-operable key are mounted. The portable device can be positioned at any suitable location, for example, inside a motor vehicle when an animal, and most typically a dog or other pet, is temporarily left inside the motor vehicle on its own. However, it will be readily appreciated that the portable device can be used in many other situations where temperature needs to be monitored from a remote location.

The temperature monitor can also be physically integrated into another product or device. In an integrated temperature monitor the various components might be dispersed throughout the product or device and might be connected together by any suitable wired or wireless means. Components such as a display screen and the at least one user-operable key might have functionality associated with other parts of the product or device in addition to being used to control and/or program the temperature monitor. For example, if the temperature monitor is integrated into a motor vehicle then the display screen might be an existing part of the motor vehicle display and the at least one user-operable key might be an existing switch, button, knob, or even part of a touch screen display, which controls other functions of the motor vehicle such as the cruise control system, sound system, or navigation system. The temperature monitor might use an existing temperature sensor that is also used by the motor vehicle as part of its climate control system, for example, or a separate temperature sensor might be provided at a suitable location for the temperature monitor. More than one temperature sensor might be used. The temperature monitor might use an existing communication unit that allows the motor vehicle to transmit and receive signals (e.g., over a GSM network), or a separate communication unit might be provided. The processor unit of the temperature monitor might be integrated with the processor unit or on-board computer of the motor vehicle.

In an exemplary arrangement the temperature monitor is programmed with both upper and lower temperature setpoints.

The temperature setpoint(s) can be programmed using one or more user-operable keys. The temperature monitor can be provided with a first user-operable key that can be used to increase a temperature setpoint and a second user-operable key that can be used to decrease a temperature setpoint. Alternatively, the temperature monitor can be provided with a user-operable key that allows the user to selectively increase or decrease a temperature setpoint depending on how it is pressed or manipulated. The temperature setpoint that is being programmed will typically be increased or decreased by a predetermined amount (e.g., by 0.5 or 1° C. or by 1˜2° F.) each time a user-operable key is pressed or manipulated.

The display screen of the temperature monitor displays the ambient temperature as measured by the temperature sensor, typically in the temperature unit (e.g. ° C. or ° F.) selected by the user.

The temperature monitor can further include indicators for indicating different operating modes or conditions of the temperature monitor.

In the case of a portable device, the temperature monitor can further include an internal battery or be powered from an external power source such as the mains or a 12 volt socket. The internal battery can be rechargeable using a conventional external power charger. If the temperature monitor is physically integrated into another device or product then it can be powered from an external power source, its own internal battery, or a power source associated with the device or product (e.g., the vehicle battery).

The processor unit can control the communication unit to transmit an alarm signal if a low battery condition is detected.

The communication unit can further include an aerial and a cellular (or mobile) telephone module that can receive a subscriber identity module (SIM) card. The user can therefore choose which GSM network and payment method (e.g., contract or ‘pay as you go’) to utilise by installing the appropriate SIM card.

The temperature monitor can further include a microphone and/or a camera of any suitable type. The processor unit can control the communication unit to transmit a signal containing sound data provided by the microphone and/or image data provided by the camera when the communication unit receives a demand signal.

The temperature monitor can further include a loudspeaker. The loudspeaker can optionally be used to provide an audible alarm or to enable the user to talk to an individual (e.g., a member of the emergency services) located at the temperature monitor. If the temperature monitor also includes a microphone then the user can use their cellular telephone or portable electronic device to have two-way communication with the individual located at the temperature monitor. In other words, the temperature monitor can be adapted to function as a communication device over the GSM network.

The present invention further provides a method of using a temperature monitor as described above, comprising the steps of using a cellular telephone or other portable electronic device to transmit a demand signal to the temperature monitor, and wherein the processor unit controls the communication unit to transmit a status signal containing data indicative of the ambient temperature measured by the temperature sensor to the cellular telephone or other portable electronic device when the communication unit receives the demand signal.

The present invention further provides a method of using a temperature monitor as described above and with a microphone and/or a camera, comprising the steps of using a cellular telephone or other portable electronic device to transmit a demand signal to the temperature monitor, and wherein the processor unit controls the communication unit to transmit a signal containing sound data provided by the microphone and/or image data provided by the camera to the cellular telephone or other portable electronic device when the communication unit receives the demand signal.

The data contained within the signals transmitted by the temperature monitor (e.g., the alarm signals and status signals with data indicative of the measured ambient temperature, the alarm signals for a low battery condition, and signals containing other data such as sound or image data) is intended to be displayed on the cellular telephone or portable electronic device. For example, if an alarm signal or status signal is received by the cellular telephone or other portable electronic device then the measured ambient temperature can be displayed on a display screen of the cellular telephone or other portable electronic device, optionally together with other suitable text such as a warning that a temperature setpoint has been reached or exceeded. The user is therefore informed of the measured ambient temperature at the remote location where the temperature monitor is positioned.

The present invention further provides a temperature monitoring and notification system comprising: a cellular telephone or other portable electronic device; and a temperature monitor comprising: a display screen, at least one user-operable key, a communication unit for transmitting and receiving signals, a temperature sensor for measuring ambient temperature, and a processor unit programmable with an upper temperature setpoint and/or a lower temperature setpoint; wherein the processor unit controls the communication unit to transmit to the cellular telephone or other portable electronic device an alarm signal containing data indicative of the ambient temperature measured by the temperature sensor if the ambient temperature reaches or exceeds the upper temperature setpoint or the lower temperature setpoint; and wherein the processor unit controls the communication unit to transmit to the cellular telephone or other portable electronic device a status signal containing data indicative of the ambient temperature measured by the temperature sensor when the communication unit receives a demand signal from the cellular telephone or other portable electronic device.

The present invention further provides a method of monitoring temperature using a temperature monitor comprising: a display screen, at least one user-operable key, a communication unit for transmitting and receiving signals, a temperature sensor for measuring ambient temperature, and a programmable processor unit; wherein the method comprises the steps of: using the at least one user-operable key to program the temperature monitor with an upper temperature setpoint and/or a lower temperature setpoint; controlling the communication unit to transmit an alarm signal to a cellular telephone or other portable electronic device, the alarm signal containing data indicative of the ambient temperature measured by the temperature sensor if the ambient temperature reaches or exceeds the upper temperature setpoint or the lower temperature setpoint; and controlling the communication unit to transmit a status signal to a cellular telephone or other portable electronic device, the status signal containing data indicative of the ambient temperature measured by the temperature sensor, when the communication unit receives a demand signal from the cellular telephone or other portable electronic device.

Further alarm signals containing data indicative of the ambient temperature measured by the temperature sensor can be sent if the ambient temperature continues to exceed the upper or lower temperature setpoint. Such further alarm signals can be transmitted periodically (e.g. every 2 minutes) for as long as the upper or lower temperature setpoint is exceeded. Alternatively, further alarm signals might be transmitted if the ambient temperature measured by the temperature sensor continues to increase after the upper temperature setpoint has been reached, or continues to decrease after the lower temperature setpoint has been reached. An alarm signal can be transmitted each time the measured ambient temperature exceeds the upper or lower temperature setpoint by a predetermined interval (e.g. 1° C. or 2° F.). For example, if the upper temperature setpoint is set to 25° C. or 77° C. then a first alarm signal would be transmitted if the measured ambient temperature reaches the upper temperature setpoint of 25° C. or 77° F., a second alarm signal would be transmitted if the measured ambient temperature reaches 26° C. or 79° F., a third alarm signal would be transmitted if the measured ambient temperature reaches 27° C. or 81° F., and so on. The temperature monitor can be adapted to transmit further alarm signals only if the measured ambient temperature continues to increase above the upper temperature threshold or continues to decrease below the lower temperature threshold. In some arrangements then further alarm signals can also be transmitted if the measured ambient temperature starts to decrease when the upper temperature setpoint is still being exceeded or if the measured ambient temperature starts to increase when the lower temperature setpoint is still being exceeded. For example, in the above example, a fourth alarm signal would then be transmitted if the measured ambient temperature falls from 27° C. to 26° C. or from 81° F. to 79° F.

If an alarm signal has been transmitted and the measured ambient temperature falls back below the upper temperature setpoint or rises back above the lower temperature setpoint (i.e., so that the temperature setpoint is no longer being exceeded) then a status signal can be transmitted. For example, in the above example, if the ambient temperature measured by the temperature sensor continued to fall then a status signal would be transmitted if the ambient temperature reached 24.9° C. or 76.9° F. so that the user is informed that the upper temperature setpoint is no longer being exceeded. It will be readily appreciated that a user can normally request a status signal from the temperature monitor at any time by sending a demand signal from their cellular telephone or other portable electrical device. However, in some cases it may be possible to transition the temperature monitor into an economy mode where an alarm signal is sent if the measured ambient temperature reaches or exceeds the upper or lower temperature setpoint but where the temperature monitor will not transmit status signals in response to a demand signal.

The method can further include the step of controlling the communication unit to transmit an alarm signal to a cellular telephone or other portable electronic device if a low battery condition is detected.

If the temperature monitor further includes a microphone and/or a camera then the method can further comprise the step of controlling the communication unit to transmit a signal to a cellular telephone or other portable electronic device, the signal containing sound data provided by the microphone and/or image data provided by the camera, when the communication unit receives a demand signal from the cellular telephone or other portable electronic device.

The alarm signal, status signal, sound data and image data can be transmitted using any suitable wireless communication protocol, e.g. in the case of alarm and status signals, the short messaging service (SMS) protocol which allows the sending and receiving of short text messages between communication devices. The alarm signal, status signal, sound data, and image data can be transmitted to one or more cellular telephone or other portable electronic device. In other words, the temperature monitor can be programmed with only one nominated telephone number or with two or more nominated telephone numbers which can also be used to check if a demand signal has been received from an authorized cellular telephone or other portable electronic device. One or more cellular telephones or other portable electronic devices can be ‘paired’ with the temperature monitor by sending a signal to the temperature monitor, e.g. by sending a short text message using the SMS protocol. The temperature monitor can also be adapted to send a status signal to any cellular telephone or other portable electronic device from which it receives a demand signal, not just the cellular telephone or other portable electronic device that it is paired with. In other words, the status signal can be sent to a telephone number associated with the cellular telephone or other portable electronic device that sends a demand signal and not just to a nominated telephone number.

All functionality of the temperature monitor, including the programming of upper and/or lower temperature setpoints, for example, can optionally be controlled remotely using a mobile application (or mobile ‘app’), i.e., a software application that is specifically designed to run on smartphones, computers, tablets, and similar devices. As well as providing a remote control function, the mobile application can optionally provide additional features including: data collection, data analysis (e.g. trends), the graphic display of temperature fluctuations over different time periods, the maximum and minimum measured temperatures over different time periods, and a real-time temperature display.

### BRIEF DESCRIPTION OF THE DRAWINGS

Exemplary embodiments of the invention will now be described, with reference to the accompanying drawings, which are intended to illustrate, not limit, the present invention. In the drawings:

FIG. 1 shows a front view of a first temperature monitor according to the present invention;

FIG. 2 shows a front view of the temperature monitor of FIG. 1 with the outer housing removed so that the internal layout is visible;

FIG. 3 shows a rear view of the temperature monitor of FIG. 1 with the outer housing and overlying internal components removed so that the internal layout is visible;

FIG. 4 shows a rear view of the temperature monitor of FIG. 1 with the outer housing removed so that the overlying internal components are visible;

FIG. 5 shows a front view of a second temperature monitor according to the present invention with a modified layout;

FIG. 6 shows a front view of the temperature monitor of FIG. 5 with the outer housing removed so that the internal layout is visible;

FIG. 7 shows a rear review of the temperature monitor of FIG. 5 with the outer housing removed so that the internal layout is visible;

FIG. 8 shows a rear view of the temperature monitor of FIG. 5; and

FIG. 9 is a schematic showing the component parts of a temperature monitor according to the present invention.

### DETAILED DESCRIPTION OF THE PREFERRED EMBODIMENTS

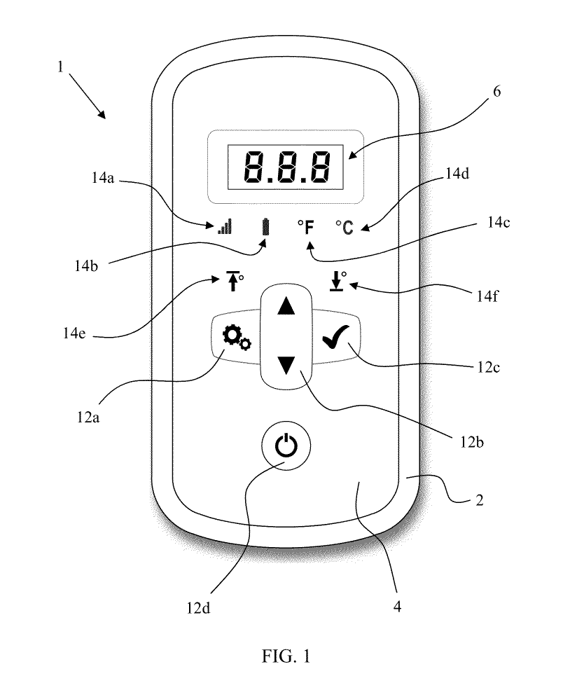

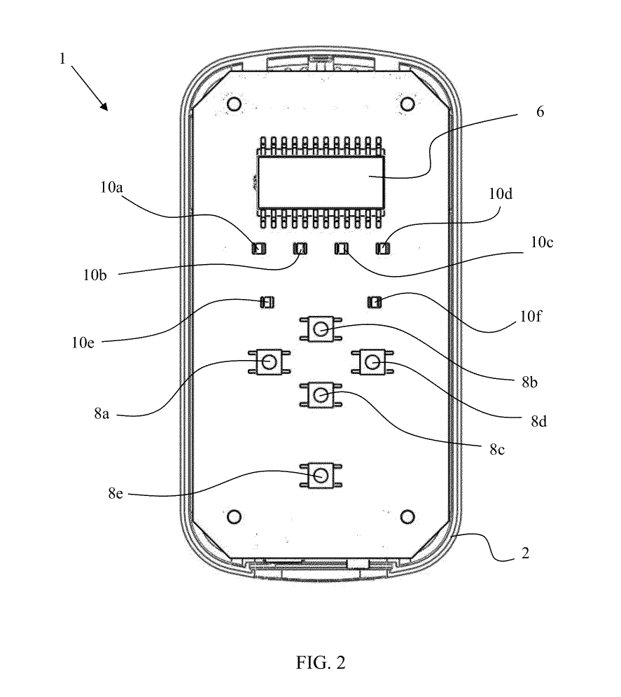

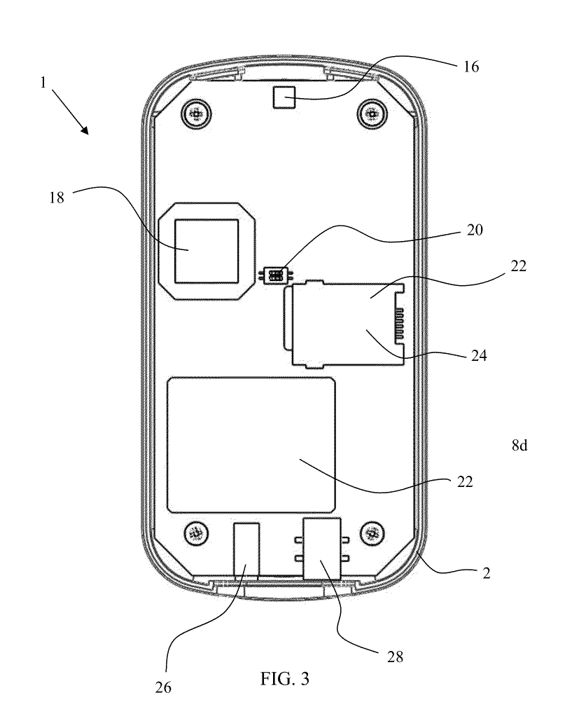

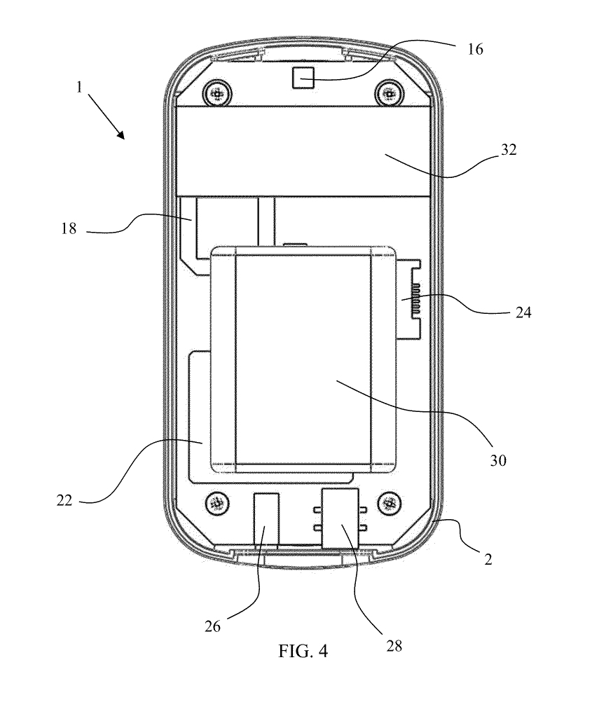

With reference to FIGS. 1 to 4, a first portable temperature monitor 1 includes a plastics outer housing 2 incorporating a graphic overlay 4 that covers a board-mounted liquid crystal display (LCD) 6, user-operable switches (tact switches) 8a-8e and light emitting diodes (LEDs) 10a-10f. The graphic overlay 4 includes areas 12a-12d overlying the user-operable switches 8a-8e and graphic indicators 14a-14f overlying the LEDs 10a-10f to indicate certain operational modes or conditions of the temperature monitor. For example, indicator 14a indicates low signal strength, indicator 14b indicates low battery, indicators 14c and 14d indicate the selected temperature unit (e.g. ° C. or ° F.), and indicators 14e and 14f indicate if the upper or lower temperature setpoint is being programmed or exceeded. The LEDs 10a-10f can be controlled to turn on and off to light up the overlying indictor and can change color (e.g. from green to red or vice versa) and/or flash on and off depending on the operational mode of the temperature monitor.

The outer housing 2 also encloses a temperature sensor 16, a user-programmable processor unit 18 mounted on a printed circuit board (PCB), a temperature select switch 20 that can adjust the temperature units between Celsius and Fahrenheit, a cellular telephone module 22 including a holder 24 which is capable of receiving a subscriber identity module (SIM) card, a connector 26 to allow the temperature monitor to be connected to an external temperature sensor (not shown), a connector 28 to allow the temperature monitor to be connected to an external power supply or battery charger (not shown), a rechargeable battery 30, and an internal aerial (radio antenna) 32 for the cellular telephone module. The internal components may be accessed by removing the back of the outer housing.

The temperature monitor is used as follows:

### Setting Up

When the temperature monitor is used for the first time then a SIM card is inserted into the card holder 24 of the cellular telephone module 22. Any short message service (SMS) text messages or telephone calls made to the temperature monitor will be made to the cellular telephone number associated with the SIM card.

A nominated cellular telephone number is programmed into the temperature monitor. This may be done by transmitting a SMS text message from a cellular telephone (or other portable electronic device) to the temperature monitor, optionally including a code that is assigned to the temperature monitor. The temperature monitor will then transmit all signals, whether SMS text messages, telephone calls, or other data transfers, to the nominated cellular telephone number.

The nominated cellular telephone number programmed into the temperature monitor can be changed by transmitting a SMS text message from a different cellular telephone (or other portable electronic device), optionally using the assigned code. In some embodiments the temperature monitor can be programmed with two or more nominated cellular telephone numbers.

### Switching on

The region 12d overlying the switch 8e (the ‘On/Off key’) is pressed and held for a certain amount of time, e.g., 3 seconds, to turn the temperature monitor on. All of the LCD screen segments may flash and the LEDs 10a-10e may be turned on for a certain amount of time, e.g., 1 second.

The LCD screen 6 will display the current temperature in either Celsius or Fahrenheit, depending on the position of the temperature select switch 20, and optionally also the battery level and signal level, i.e., the strength of the cellular telephone signal.

### Setting the Upper and Lower Temperature Setpoints

The region 12a overlying the switch 8a (the ‘Edit’ key) is pressed once to allow the user to set the upper temperature setpoint. The LED 10e underneath the upper temperature setpoint indicator 14e flashes to show that the user is editing the upper temperature setpoint and the LCD screen 6 shows the upper temperature setpoint that is currently being programmed. The region 12b overlying the switches 8b, 8c (the ‘Up/Down’ key) is pressed to adjust the upper temperature setpoint and the new upper temperature setpoint is shown on the LCD screen 6.

It will normally be possible to set the upper temperature setpoint to be below the current ambient temperature but the LED 10e underneath the upper temperature setpoint indicator 14e may change color (e.g. from green to red) to inform the user.

Once the desired upper temperature setpoint has been reached, the region 12c overlying the switch 8d (the ‘Set’ key) is pressed to program the upper temperature setpoint and store it in the processor unit 18.

Once the upper temperature setpoint has been programmed, the user can set the lower temperature setpoint in a similar manner. The LED 10f underneath the lower temperature setpoint indicator 14f flashes to show that the user is editing the lower temperature setpoint and the LCD screen 6 shows the lower temperature setpoint that is currently being programmed. The ‘Up/Down’ key is pressed to adjust the lower temperature setpoint and the new lower temperature setpoint is shown on the LCD screen 6.

It will normally be possible to set the lower temperature setpoint to be above the current ambient temperature but the LED 10f underneath the lower temperature setpoint indicator 14f may change color (e.g. from green to red) to inform the user.

Once the desired lower temperature setpoint has been reached, the ‘Set’ key is pressed to program the lower temperature setpoint and store it in the processor unit 18.

The upper and lower temperature setpoints may be varied in predetermined intervals, e.g., 1° C. or 1˜2° F. each time the ‘Up/Down’ key is pressed.

It will be readily appreciated that an alternative option is for the lower temperature setpoint to be set before the upper temperature setpoint. Other ways of setting the upper and lower temperature setpoints are also possible, for example using a mobile application (or mobile ‘app’). Only an upper or lower temperature setpoint can be set in some cases, for example, in summer months when only high temperatures are of concern.

If the upper temperature setpoint is programmed below the ambient temperature or the lower temperature setpoint is programmed above the ambient temperature then the temperature monitor will transition to the alarm mode described in more detail after a certain delay, e.g., 2 minutes.

It will not normally be possible to set the lower temperature setpoint above the upper temperature setpoint or vice versa.

### Normal Mode

During use the processor unit 18 will continuously compare the ambient temperature as detected by the temperature sensor 16 (or an external temperature sensor if connected) against the upper and lower temperature setpoints. The battery level is also monitored. Depending on where it is positioned, the temperature monitor can be used to measure an outside temperature or the temperature within a space such as a motor vehicle or the room of a house, for example. The temperature monitor will be particularly useful for situations where an animal, and most typically a dog, is temporarily left inside a motor vehicle while the owner is absent, but it can be used in many other situations where temperature needs to be monitored from a remote location. An external temperature sensor can be connected to the temperature monitor by any suitable wired or wireless means. In an alternative arrangement, not shown, the temperature monitor can be physically integrated into a motor vehicle with the various components being dispersed through the motor vehicle and optionally also having additional functionality associated with other parts of the motor vehicle.

The temperature monitor will respond to any incoming demand signals as described in more detail below.

The LED 10a underneath the low signal strength indicator 14a can be made to flash if the strength of the cellular telephone signal falls below a certain level.

### Alarm Mode

There are three situations in which the temperature monitor will transition to the alarm mode, namely:

If the ambient temperature reaches or rises above the upper temperature setpoint

If the ambient temperature reaches or falls below the lower temperature setpoint

If a low battery condition is detected

In alarm mode the temperature monitor will automatically transmit an alarm signal, preferably a SMS text message, to the nominated cellular telephone number(s).

For a temperature alarm, the SMS text message will include the current temperature in either Celsius or Fahrenheit depending on the position of the temperature select switch 20, together with a suitable warning, which may state that the upper or lower temperature setpoint has been reached or exceeded:
WARNING! Current temperature ??° C.—high temperature limit exceeded

The ambient temperature displayed on the LCD screen 6 can be made to flash and the LED 10e, 10f underneath the respective upper and lower temperature setpoint indicator 14e, 14f may also flash or change color.

If the ambient temperature remains at or above the upper temperature setpoint or remains at or below the lower temperature setpoint then the temperature monitor can continue to automatically transmit an alarm signal to the nominated cellular telephone number(s) at a certain interval, e.g., every 2 minutes.

An alarm signal can also be automatically sent to the nominated cellular telephone number(s) each time the ambient temperature increases or decreases by a certain amount, e.g., 1° C. or 1˜2° F., while the ambient temperature remains at or above the upper temperature setpoint or remains at or below the lower temperature setpoint. For example, if the upper temperature setpoint is set to 25° C. or 77° C., then a first alarm signal would be transmitted if the ambient temperature reaches 25° C. or 77° F., a second alarm signal would be transmitted if the ambient temperature reaches 26° C. or 79° F., a third alarm signal would be transmitted if the ambient temperature reaches 27° C. or 81° F., and so on.

If the ambient temperature falls below the upper temperature setpoint or rises above the lower temperature setpoint then the temperature monitor will return to the normal mode. A signal (e.g., a status signal) can be automatically sent to the nominated cellular telephone number(s) to inform the user that the temperature monitor is no longer in the alarm mode.

The temperature monitor may provide an audible alert while in the alarm mode.

For a low battery alarm then the SMS text message will include a suitable warning such as:

WARNING! Low battery detected

The LED 10b underneath the low battery indicator 14b may be made to flash.

### Switching Off

The ‘On/Off key’ is pressed and held for a certain amount of time, e.g., 3 seconds, to turn the temperature monitor off. The LCD screen 6 and LEDs 10a-10f are turned off and the temperature monitor goes into a sleep mode.

### Reporting on Demand

When the temperature monitor is in the normal mode it is possible to make the temperature monitor transmit a status signal, preferably a SMS text message, to the nominated cellular telephone number(s) or to the telephone number associated with any cellular telephone (or other portable electronic device) that transmits a demand signal to the temperature monitor. The status signal will include the current temperature in either Celsius or Fahrenheit depending on the position of the temperature select switch 20. A status signal (or its equivalent) can also be transmitted if an alarm signal has been transmitted and the ambient temperature falls below the upper temperature setpoint or rises above the lower temperature setpoint so that the temperature monitor transitions from an alarm mode to a normal mode.

The temperature monitor can be made to transmit the status signal by calling the temperature monitor or transmitting a SMS text message to the temperature monitor from a cellular telephone (or other portable electronic device). If a call is made then the temperature monitor will recognize the incoming cellular telephone number and when the call is ended will then transmit a status signal to that cellular telephone number. In some arrangements the temperature monitor will then only send a status signal to a nominated telephone number. If a SMS text message is sent to the temperature monitor then it may optionally include a code to tell the temperature monitor to send the status signal. Different codes may be used to control the temperature monitor remotely, and may even be used to program or vary the upper and lower temperature setpoints and control other operational functions. Alternatively, and as noted briefly above, the temperature monitor may be controlled and/or programmed remotely by means of a suitable mobile application (or mobile ‘app’).

The status signal can also include non-critical information such as battery level remaining, current signal strength, time switched on, and the upper and lower temperature setpoints, for example.

In an alternative version (not shown) the temperature monitor may include a microphone, a camera and/or a loudspeaker. It is possible to make the temperature monitor transmit a signal containing sound data provided by the microphone and/or image data provided by the camera to the nominated cellular telephone number(s). The user may then listen to the sounds detected by the microphone and/or view the images captured by the camera on their cellular telephone (or portable electronic device). The temperature monitor can be made to transmit the signal by calling the temperature monitor or transmitting a SMS text message to the temperature monitor from a cellular telephone (or other portable electronic device) as described above.

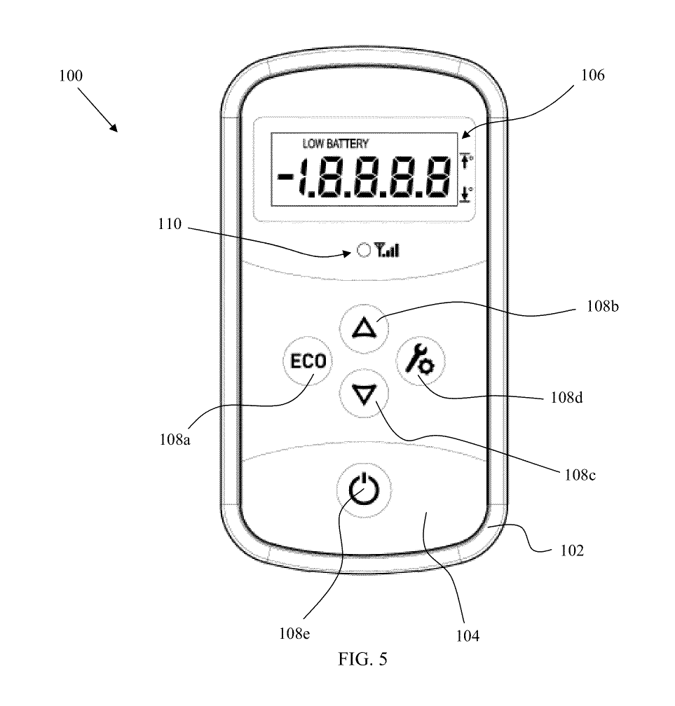

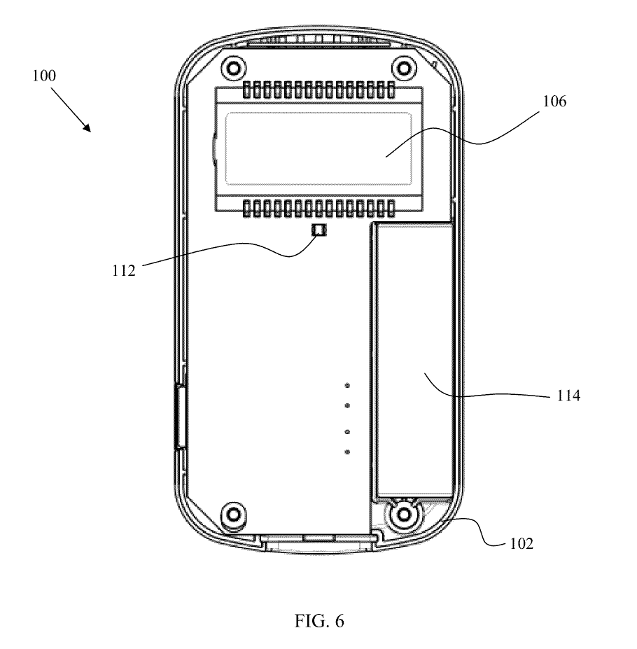

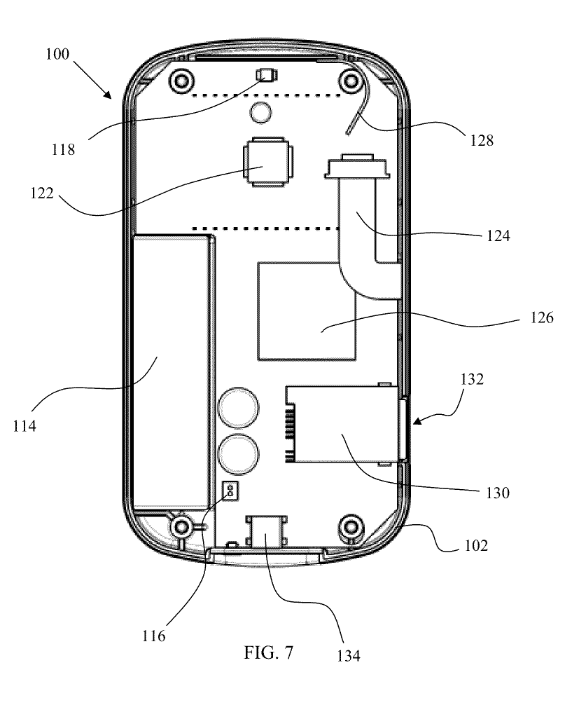

With reference to FIGS. 5 to 8, a second portable temperature monitor 100 having a different layout includes a plastics outer housing 102 incorporating a graphic overlay 104 that covers a board-mounted LCD 106. The graphic overlay 104 includes areas 108a-108e that form part of a membrane keymat and a graphic indicator 110 overlying an LED 112 to indicate a low signal strength.

The area 108e represents an ‘On/Off key’ that is equivalent to area 12d overlying button 8e in the first portable temperature monitor 1 shown in FIGS. 1 to 4.

The area 108d represents an ‘Edit/Set’ key that is equivalent to areas 12a and 12c overlying switches 8a and 8d in the first portable temperature monitor 1 of FIGS. 1 to 4.

With cross-reference to the embodiment of FIGS. 1 to 4, the area 108b represents an ‘Up’ key that is equivalent to the part of area 12b overlying the switch 8b and the area 108c represents a ‘Down’ key that is equivalent to the part of area 12b overlying the switch 8c in the first portable temperature monitor 1.

The area 108a represents an ‘Eco’ key that can be pressed to transition the temperature monitor into an economy mode. Such a mode is suitable for long term temperature monitoring as it conserves the internal battery by switching on automatically when a temperature setpoint is reached, then switching off after a predetermined period of time. The economy mode is suitable for use when rapid temperatures changes would not normally occur. In an economy mode the temperature monitor will transmit alarm signals but not status signals.

A battery 114 is provided within the outer housing and is connected to a PCB by means of a connector 116.

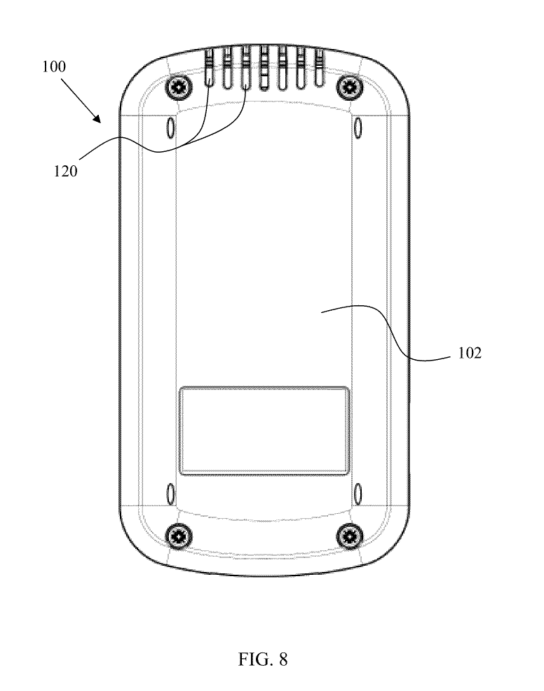

The outer housing 102 includes a temperature sensor 118 that is mounted adjacent vents 120 that are provided in the rear of the outer housing as shown in FIG. 8 and which allow air to flow into the interior of the device.

A user-programmable processor unit 122 is mounted on the PCB.

The membrane keypad that defines switch areas 108a to 108e is connected to the PCB by means of a connector 124.

A cellular telephone module 126 includes a GSM antenna 128 and a holder 130 that is capable of receiving a subscriber identity module (SIM) card through an aligned slot 132 in the outer housing 102.

A universal serial bus (USB) connector 134 is provided.

The other components and operational features of the portable temperature monitor 100 are as described above with reference to FIGS. 1 to 4.

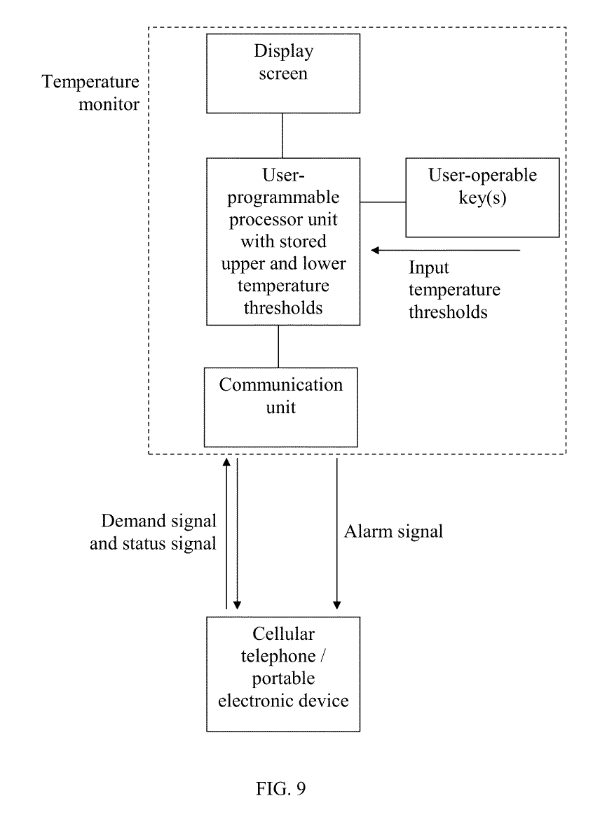

FIG. 9 shows the various component parts of the temperature monitor according to the present invention, which in the case of an integrated monitor can optionally be dispersed throughout another device or product such as a motor vehicle, for example.

It is apparent that variations and modifications to the present teaching as possible without departing for the scope and spirit of the teachings. It is therefore to be understood that the appended claims are to be construed as encompassing all features of patentable novelty that reside in the present teachings, including all features that would be treated as equivalent thereof by those skilled in the art to which the present teachings pertain.

What is claimed is:

1. A temperature monitor comprising:
a display screen;
at least one user-operable key;
a communication unit for transmitting and receiving signals;
a temperature sensor for measuring ambient temperature; and
a processor unit programmable with one or both of an upper temperature setpoint and a lower temperature setpoint;
wherein the processor unit controls the communication unit to transmit an alarm signal containing data indicative of the ambient temperature measured by the temperature sensor if the ambient temperature reaches or exceeds the upper temperature setpoint, or reaches or falls below the lower temperature setpoint; and
wherein the processor unit controls the communication unit to transmit a status signal containing data indicative of the ambient temperature measured by the temperature sensor when the communication unit receives a demand signal.

2. The temperature monitor of claim 1, further comprising an internal battery, wherein the processor unit controls the communication unit to transmit an alarm signal if a low battery condition is detected.

3. The temperature monitor of claim 1, wherein the communication unit further comprises an aerial and a cellular telephone module that can receive a subscriber identity module (SIM) card.

4. The temperature monitor of claim 1, further comprising one or both of a microphone and a camera, and wherein the processor unit controls the communication unit to transmit a signal containing one or both of sound data provided by the microphone and image data provided by the camera when the communication unit receives a demand signal.

5. The temperature monitor of claim 1, wherein the processor unit is programmed with an upper temperature setpoint and a lower temperature setpoint.

6. The temperature monitor of claim 1, packaged as a portable device.

7. In combination, the temperature monitor of claim 1 and another device, wherein the temperature monitor is physically integrated into the other device.

8. A temperature monitoring and notification system comprising:
a cellular telephone or other portable electronic device; and
a temperature monitor comprising:
a display screen;
at least one user-operable key;
a communication unit for transmitting and receiving signals;
a temperature sensor for measuring ambient temperature; and
a processor unit programmable with one or both of an upper temperature setpoint and a lower temperature setpoint;
wherein the processor unit controls the communication unit to transmit to the cellular telephone or other portable electronic device an alarm signal containing data indicative of the ambient temperature measured by the temperature sensor if the ambient temperature reaches or exceeds the upper temperature setpoint, or reaches or falls below the lower temperature setpoint; and
wherein the processor unit controls the communication unit to transmit to the cellular telephone or other portable electronic device a status signal containing data indicative of the ambient temperature measured by the temperature sensor when the communication unit receives a demand signal from the cellular telephone or other portable electronic device.

9. A method of monitoring temperature using a temperature monitor comprising: a display screen, at least one user-operable key, a communication unit for transmitting and receiving signals, a temperature sensor for measuring ambient temperature, and a programmable processor unit;
wherein the method comprises the steps of:
using the at least one user-operable key to program the temperature monitor with one or both of an upper temperature setpoint and a lower temperature setpoint;
controlling the communication unit to transmit an alarm signal to a cellular telephone or other portable electronic device, the alarm signal containing data indicative of the ambient temperature measured by the temperature sensor if the ambient temperature reaches or exceeds the upper temperature setpoint, or reaches or falls below the lower temperature setpoint; and
controlling the communication unit to transmit a status signal to a cellular telephone or other portable electronic device, the status signal containing data indicative of the ambient temperature measured by the temperature sensor, when the communication unit receives a demand signal from the cellular telephone or other portable electronic device.

10. The method of claim 9, wherein the temperature monitor further comprises an internal battery and the method further comprises the step of controlling the communication unit to transmit an alarm signal to a cellular telephone or other portable electronic device if a low battery condition is detected.

11. The method of claim 9, wherein the temperature monitor further comprises one or both of a microphone and a camera, and the method further comprises the step of controlling the communication unit to transmit, to a cellular telephone or other portable electronic device, a signal containing one or both of sound data provided by the microphone and image data provided by the camera, when the communication unit receives a demand signal from the cellular telephone or other portable electronic device.

12. The method of claim 9, further comprising the step of controlling the communication unit to transmit a further alarm signal to the cellular telephone or other portable electronic device if the ambient temperature measured by the temperature sensor continues to exceed the upper temperature setpoint or continues to remain below the lower temperature setpoint.

13. The method of claim 9, further comprising the step of controlling the communication unit to transmit a signal to the cellular telephone or other portable electronic device if the ambient temperature measured by the temperature falls below the upper temperature setpoint or rises above the lower temperature setpoint.

14. The method of claim 9, further comprising the step of programming the temperature monitor to be in an economy mode wherein the communication unit can be controlled to transmit an alarm signal but cannot be controlled to transmit a status signal in response to a demand signal.

15. The method of claim 9, wherein the temperature monitor is controlled, programmed, or both, using a mobile application.
